(19) United States
(12) Patent Application Publication
(10) Pub. No.: US 2007/0256506 A1
(43) Pub. Date: Nov. 8, 2007

(54) Method and Device for Measuring

(75) Inventor: Bart Sette, Oudenaarde (BE)

Correspondence Address: GIFFORD, KRASS, SPRINKLE,ANDERSON & CITKOWSKI, P.C, PO BOX 7021, TROY, MI, 48007-7021, US

(73) Assignee: Ghent University, Gent (BE)

(21) Appl. No.: 11/720,139

(22) PCT Filed: Nov. 25, 2005
(86) PCT No.: PCT/BE05/00172

§ 371 Date: May 24, 2007

(30) Foreign Application Priority Data
Nov. 26, 2004 (GB) 0426007.1

(51) Int. Cl. G01F 1/34

(52) U.S. Cl. 73/861.42

(57) ABSTRACT

The invention relates to a pressure probe for characterizing the pressure and/or differential pressure in a fluid, and all derivatives, like for instance, flow rate. The device comprises a front side adapted for facing an upstream direction of the fluid flow, a bulbous part adapted for creating a region of low pressure, also called wake, and a flow detachment means. The front side allows creation of a region of high pressure. It has a planar shape or the shape of a recess. The device thus allows to be substantially flow angle independent, to be Reynolds number independent in a wide range of flow velocities and to obtain a large differential pressure gain.

### REFERENCE TO RELATED APPLICATIONS

This application is the U.S. national phase of PCT/BE05/000172, filed Nov. 25, 2005, which claims priority from application No. GB0426007.1, filed Nov. 26, 2004, the entire content of both of which are incorporated herein by reference.

### FIELD OF THE INVENTION

The present invention relates to a method and device for measuring pressure. More particularly, the present invention relates to a method and a device for determining pressure in a fluid, a method and device for measuring a differential pressure and a method and device for obtaining derived values like for example the flow velocity of a fluid or the direction of a flow.

### BACKGROUND OF THE INVENTION

The evaluation of the pressure and velocity field is an essential part of fluid dynamics Total and static pressure have to be measured over a wide range of Mach and Reynolds numbers to define the forces on bodies and walls and to obtain the local magnitude and direction of the fluid velocity The main parameters influencing the measurements are incidence, Reynolds number, Mach number, velocity gradients, proximity of walls, unsteadiness of the flow and probe geometry. The velocity magnitude and/or the volume flow can be obtained from the pressure drop across a body or a restriction, e.g., in a duct, and is often called a differential pressure measurement. Differential pressure flow meters are an important category of instruments that sense for the momentum of the flow. They have a long and distinguished history and still dominate the flow measurement scene. A large number of differential pressure flow meters exists, such as e.g., orifice plates, venturi meters and nozzles, Pitot-static tubes and shielded (Kiel) probes, incidence insensitive static pressure probes, averaging Pitots for measuring flows in pipes, etc.

Differential pressure flow meters can be used in a plurality of applications, e.g. for testing and evaluating building products for their behaviour in case of a fire. In recent years, most building materials on the European market that need to fulfil a reaction to fire requirement are classified based upon the heat they release and the smoke they produce when exposed to a fire. These measurements—which are based on the oxygen depletion technique—require real time knowledge of the oxygen and carbon dioxide concentration and the flow in the extraction duct.

Orifice plates, venturi meters and nozzles typically are for use in pipes. They form a contraction in the pipe diameter thus generating a difference in pressure over the object. The orifice plate flow meter is the most common industrial instrument. It is easy to construct, straightforward to install arid well defined and documented. The main disadvantages however are that it generates a high-pressure loss, that it is nonlinear and that it is sensitive to installation effects and mechanical wear. Those high-pressure losses can be reduced using a venturi meter, which is also less affected by upstream flow distortions. However, the initial installation costs are much higher, a considerable length of the pipe for probing is required and it generates a differential pressure that is lower for a same area ratio than for the orifice.

The use of Pitot-static tubes is not restricted to the use in pipes. They have the advantage that they can be designed such that they are not very sensitive to angles of attack. These probes are well known to the person skilled in the art. An example of a Pitot-static tube is shown in FIG. 1a. For simple, non-shielded tubes, the usable angular range, i.e. with differential pressure variations of less than 1%, was found to depend on the external shape of the nose section, the size of the impact opening relative to the tube diameter, and the shape of the internal chamber behind the impact opening. It was concluded that the best combination of these design features is a tube having a cylindrical nose shape, an impact-opening equal to the tube diameter, and a 30° conical chamber. The usable range in this case is roughly between +28° and −28° at a Mach number M of 0.26. It was further concluded that for most of the unshielded tubes the usable range increases with Mach number, whereas for shielded tubes it decreases with Mach number. Extreme values of insensitivity are obtained with shielded probes. The insensitivity range of a shielded tube having a conical entry is roughly between +41° and −41° (M=0.26). Changing the shape of the entry of the shield to a highly curved section increases this range to roughly between +63° and −63° (M=0.26). This design requires venting of the throat through the wall of the shield. Although Pitot tubes can be designed such that they are independent from the Mach number (M<0.85 and Re>200), as described by Van den Braembussche in Measurement Techniques in Fluid Dynamics—An Introduction (1994), and that they have a wide range of insensitivity to angular variations, their main disadvantage is that the pressure ports easily can get obstructed by particles transported by the medium, resulting in false readings. Especially the positive total pressure port, which points upstream, is sensitive to blockage. The Pitot tube therefore is not suited for measurement in contaminated environments, such as smoke, dust, soot, etc. Their main application is for use in laboratories and aeronautical applications.

The type “S” (Stauscheibe) or Reverse Pitot-Static probe consists FIG. 1b) of two stainless steel tubes with impact holes oriented at 180° angles to one another. One hole faces upstream for the measurement of total pressure; the other is aligned in a downstream direction for static pressure measurement. The difference between these two pressures approximately equals 150% of the velocity pressure of the fluid. “S” probes are designed for easy entry into small holes in stack or flow passage walls, and due to their relatively large impact (sensing) holes, are especially effective in the presence of high concentrations of clogging particulate matter. The “S” probe however is sensitive to angular variations, which are even different for pitch and yaw angle variations, and is Reynolds dependent.

For low speed flows (M<<I) incidence insensitive static probes have been developed that are based on measuring the static pressure in the cavity downstream a blunt body with sharp edges. Two examples thereof are illustrated by the probes 10 shown in FIG. 1c and FIG. 1d. The sharp edges 12 make that the separation point is fixed independent of the Reynolds number. The reading of the probe 10 may be different from the real static pressure and a calibration is needed. The angular insensitivity is in the order of +20°.

Venturi Probes are used to amplify the measured velocity pressure in a flowing fluid. The Pitot-static flow is accelerated in the venturi passages, as in a flow nozzle, so that the dynamic pressure increases and the static pressure reading is lower than that obtained with a Pitot-static probe. According to the particular design, values of up to 8 times the velocity head are obtained. Even higher factors, up to 14, have been obtained with double-venturi probes. Disadvantages here are the relatively high probe diameter compared to a Pitot, the dependence on Reynolds number and the sensitivity to angular variations.

Besides flanges, nozzles and to a lesser extent venturis, averaging Pitots are often used in industry to measure flows. It is in effect a multi-port averaging Pitot. A front view of a multi-port averaging Pitot system 20, as well known from the prior art, is shown in FIG. 2a. The flow element operates by sensing an impact pressure and a reference pressure through multiple sensing ports 22 at specific locations across a pipe 24, connected to dual averaging plenums. The resultant difference is a differential pressure signal. Sensing ports are located on both the up and downstream sides of the flow element. The number of ports is proportional to the pipe diameter. Several designs are available (Annubar®, Torbar®, etc), each claiming superior hydrodynamic flow characteristics. The bluff-body 30 shown in FIG. 2b has a square shape that establishes a fixed separation point of the fluid from the sensor. The fixed separation point reduces changes in the low pressure and makes the probe Reynolds independent in a wide practical range. A disadvantage of this design may be that the probe traverses the duct causing an important obstruction for the flow with a corresponding pressure loss. Furthermore it may be necessary to introduce corrections to account for the bluff-body blockage effect. The axial alignment usually is also critical.

To date a bi-directional low-velocity differential pressure probe, further also referred to as bi-directional probe 40, as shown in FIG. 3, is often used to measure flow in combustion gasses. The probe consists of a section of a circular tube with a barrier midway between the end points which divides the tube into two chambers. It was first introduced by McCaffrey & Heskestad in Combustion and Flame 26 (1976) 125-127 and was named a ‘bi-directional’ probe because of its symmetry around a plane perpendicular to the probes axis. It was first developed to measure air and smoke movements in fires where the velocity direction can reverse in the course of a fire. The ‘bi-directional’ probe 40 has a differential pressure gain of around 10% with respect to a Pitot-static tube. It is suited to measure in sooty environments since there is no flow through the probe and the pressure taps are placed at the back of the chambers, perpendicular to the flow direction. Its main disadvantage however is its sensitivity to angular distortions. Roughly speaking one could say that the error on the derived velocity is in the order of 1% per degree initially to reach a maximum of about 12% to 15% at 25 degrees. This may be good enough in the harsh conditions of a fire but clearly isn't good enough when for example measuring volume flows in ducts.

None of the above-described prior art documents allow to combine flow direction angular independence, a large Reynolds independency and a high differential pressure gain Therefore there is a strong need for a robust pressure probe that is suited for correctly measuring flows of fluids, such as e.g. combustion gases, and which is insensitive to small angular variations of the probe with respect to the flow. Since in many applications the conditions of the fluids to be measured may change a lot, e.g. like in fire testing equipment wherein both temperature and gas concentration change continuously when running fire tests, the probe factor, which relates the flow velocity with the differential pressure measured over the probe, should preferably be Reynolds independent in a wide range of Reynolds numbers (Re).

### SUMMARY OF THE INVENTION

It is an object of the present invention to provide a system and method for measuring pressure and/or a differential pressure using a probe that combines a large angular independency, a large Reynolds independency and a high differential pressure gain. The above objective is accomplished by a method and device according to the present invention. The invention relates to a pressure measurement device or pressure probe for characterising a pressure in a fluid. The probe comprises a front side adapted for facing upstream said fluid wherein said front side is planar or comprises a recess, a flow detachment means, and said probe furthermore comprises a bulbous part adapted for creating, in co-operation with said flow detachment means, a region of low pressure. The recess may be concave. The fluid may have a flow direction whereby for every flow angle of said fluid with respect to a perpendicular direction to said front side, said flow angle being between +30° and −30°, preferably between +40° and −40°, more preferably between +50° and −50°, the characterised measured pressure difference in said fluid may differ less than 10%, preferably less than 5%, with respect to the measured pressure difference for a flow direction being said perpendicular direction. Thereby said perpendicular direction to the front side of the device is the reference position having zero angle. Said perpendicular direction may be the preferential flow direction. With “measured pressure difference”, “the square root of the measured pressure difference” may be meant.

The bulbous part may have an outer surface, wherein at least part of said outer surface may have a rotational symmetrical shape. At least part of said outer surface may have a spherical or partly spherical shape, a semispherical or truncated semi-spherical shape, a partial cylindrical shape, a semi-oval or truncated semi-oval shape, a semi-elliptical or truncated semi-elliptical shape, an ogival or truncated ogival shape, a conical or truncated conical shape or a parabolic or truncated parabolic shape or any combination of the above shapes. In preferred embodiments, the outer surface of the bulbous part has a spherical shape, partly spherical shape, a semi-spherical or truncated semi-spherical shape, a semi-oval or truncated semi-oval shape, a semi-elliptical or truncated semi-elliptical shape, an ogival or truncated ogival shape, or a parabolic or truncated parabolic shape, or any combination thereof. The radius of curvature of the outer surface may be smaller than 100 times the maximum diameter of the probe measured perpendicularly to the rotational symmetry axis of the probe, preferably smaller than 10 times said maximum, even more preferably smaller than S times said maximum diameter, still more preferably smaller than 2 times said maximum diameter. The length of the probe in the direction of the rotational symmetry axis of the probe may be at least 0.05 times the maximum diameter of the probe measured perpendicular to the rotational symmetry axis of the probe and may be smaller than 3 times the maximum diameter of the probe measured perpendicularly to the rotational symmetry axis of the probe, preferably smaller than 2 times said maximum, even more preferably smaller than 1 time said maximum diameter.

The front side may comprise a recess having an inner surface that has a rotational symmetrical shape. The inner surface may have any of a semispherical or truncated semi-spherical shape, a partial cylindrical shape, a semi-oval or truncated semi-oval, a semi-elliptical or truncated semi-elliptical shape, a conical or truncated conical shape, a parabolic or truncated parabolic shape, or an ogival or truncated ogival shape. The inner surface may be a combination of any of these shapes.

The recess may have a maximum diameter d₁ and said bulbous part may have a maximum diameter d₃ in the direction perpendicular to said axis of rotational symmetry, such that the ratio of the maximum diameter d₃ of said bulbous part to said maximum diameter d₁ of said recess may be smaller than 2, preferably smaller than 1.5, more preferably smaller than 1.25. In specific embodiments, the cross-section of the front side of the recess may be at least 70%, preferably 80%, more preferably 90%, even more preferably 95% of the cross-section of the front side of the probe. The recess may be positioned completely in the volume defined by the bulbous part of the device. The bulbous part furthermore may comprise a planar back side, adapted for facing downstream direction of said fluid flow, said planar back side having a diameter d₄ in the direction perpendicular to said axis of rotational symmetry, such that the ratio of said diameter of the planar back side of the bulbous part to said maximum diameter of the bulbous part may be smaller than 0.5, preferably smaller than 0.3. The recess furthermore may have a planar back with a minimum diameter d₂, such that said the ratio of said maximum diameter d₁ to said minimum diameter d₂ may be larger than 2, preferably larger than 3, more preferably larger than 4, even more preferably larger than 6, still more preferably larger than 10.

The means for flow detachment may be any of an edge, a rim, a rib, a fin or a surface roughness. The surface roughness may be provided on the surface of the device facing stream upward.

The device furthermore may comprise at least one high pressure sensing port in said front surface The device furthermore may comprise at least one high pressure sensing port in said bulbous part with an open end in said front surface. The device furthermore may comprise at least one low pressure sensing port in said region of low pressure. The device may furthermore comprise at least one low pressure sensing port with an open end in said region of low pressure. The high pressure sensing port is intended for measuring pressure at that side of the device where the pressure is higher—hence the name high pressure sensing port. The low pressure sensing port is intended for measuring pressure at that side of the device where the pressure is lower—hence the name low pressure sensing port. The pressure probe may be used for measuring flow rate in a flowing fluid. The device furthermore may comprise a means to sense the differential in pressures between said at least one high-pressure port and said at least one low pressure port. Furthermore, the device may comprise a means for determining a relative flow rate of the fluid. The device may comprise a means to determine from said pressure measurement, a relative flow rate of the fluid. The means may be adapted for determining the relative flow rate of the fluid from said differential pressure measurement.

The outer surface may have a spherical or partly spherical shape. The inner surface may have a spherical or partly spherical shape, such that a spherical or partly spherical shell is formed. The outer surface may have a hemi-spherical shape. The front surface alternatively may be planar.

The at least one low and/or high pressure sensing port located near or in the device may be oriented such that their cross-section is substantially parallel to a flow direction of the fluid, i.e. typically such that the sensing ports are perpendicular to the flow direction or typically to the axis of rotational symmetry of the device. The at least one low pressure port may be located on the axis of the probe.

The probe factor kₚ, is defined by

$${k}_{p} = \sqrt{\frac{Δ p}{{p}_{tot} - {p}_{stat}}}$$

with Δp the differential pressure measured over the probe, pₜₒₜ the total pressure and pₛₜₐₜ the static pressure of the flow is function of Reynolds number and Mach number. For incompressible Newtonian flow the probe factor is function of Reynolds number only,

$${k}_{p} = \sqrt{\frac{Δ p}{{p}_{tot} - {p}_{stat}}} = \sqrt{\frac{Δ p}{\frac{1}{2} {pv}^{2}}} = f ( Re )$$

with p the P the density of the fluid and ν the flow rate of the fluid.

The probe factor kₚ, with

$${k}_{p} = \sqrt{\frac{Δ p}{{p}_{tot} - {p}_{stat}}}$$

with Δp the differential pressure measured over the probe, pₜₒₜ the total pressure and pₛₜₐₜ the static pressure of the flow, may be larger than 1.18, preferably larger than 1.20, even more preferably larger than 1.21, for a Reynolds number, within a range with a lower limit of 10⁴, preferably of 10³, more preferably of 10², even more preferably of 10, still even more preferably of 1 and an upper limit of 6.10⁴, preferably of 10⁵, more preferably of 10⁶, even more preferably of 10⁷, still even more preferably of 10⁸; and a Mach number with an upper limit of 0.3, preferably of 0.4, more preferably of 0.6, even more preferably of 0.8, still even more preferably of 1. It is expected that for large Reynolds numbers, larger than 10⁵, the probe factor is substantially independent from Reynolds number.

The open end of the at least one low pressure sensing port may be positioned in a cylinder facing downstream, coupled to said bulbous part. The 15 said open end of the at least one low pressure sensing port may be positioned in an open cylinder facing a downstream direction of the fluid flow, which cylinder is coupled to said bulbous part.

The invention also relates to a method for sensing or determining a pressure in a fluid, the method using any of the pressure probes as described above. The method may comprise sensing a differential pressure or performing a differential pressure measurement. The pressure measurement may be performed in situ.

The method furthermore may comprise determining the relative flow rate of a fluid from results of said differential pressure measurement. The method may comprise deriving a flow direction. Deriving a flow direction may be based on a steep fall in pressure or any other characteristic part of the graph of probe factor versus flow angle direction.

The method furthermore may comprise determining a temperature of said fluid The method furthermore may comprise combining said determined temperature and said flow rate to obtain a mass flow rate.

The method may comprise using a pressure probe as described above for obtaining a single pressure value and furthermore may comprise obtaining another pressure value and determining a flow rate based on said single pressure value and said another pressure value. Said pressure value may be measured using another pressure measuring means or may be a reference value or a value obtained from literature, by estimation, etc.

It is an advantage of the pressure probes for characterising pressure and/or differential pressure according to the embodiments of the present invention that they are adapted so as to be substantially angle-independent, substantially Reynolds number independent and allow a high differential pressure gain.

It is an advantage of the embodiments of the present invention that a Reynolds independency in a wide range is combined with an angular insensitivity.

It is an advantage of the present invention that it can be used for measuring speeds of objects in motion and/or for measuring speeds of fluids and/or for determining the flow direction of a fluid.

It is furthermore an advantage of the embodiments of the present invention that it is suitable for measuring in ‘dirty’ media e.g. fluids containing soot, dust, impurities, etc.

It is also an advantage of the embodiments of the present invention that they have a differential pressure gain of more than 30%, preferably more than 40%, more preferably more than 44%, even more preferably more than 48%, still more preferably more than 50% with respect to the dynamic pressure, as measured by a Pitot-static tube over broad ranges.

It is furthermore an advantage of the present invention that it has a high degree of simplicity such that it is easy to produce and install, and that it has a limited size. The design of the probe is straightforward and easy to maintain. It therefore is a competitive alternative to Pitot tubes orifice plates, venturi meters and the like.

It is also an advantage of the present invention that it produces low head losses.

It is furthermore an advantage of the present invention that the typical shape of the device used combines a large Re independency, a high differential pressure gain and a high angular insensitivity with the possibility to have a limited size, to work in ‘dirty’ environments and the possibility to manufacture the device easily in a wide variety of materials.

It is also an advantage of the present invention that none of the prior art devices combines the above-mentioned advantages in a single design. Although there has been constant improvement, change and evolution of devices in this field, the present concepts are believed to represent substantial new and novel improvements, including departures from prior practices, resulting in the provision of more efficient, stable and reliable devices of this nature.

The teachings of the present invention permit the design of improved methods and apparatus for measuring flow rate.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1a—prior art shows a typical Pitot-static tube, as known from the prior art.

FIG. 1b—prior art shows a type “S” or Reverse Pitot-static pressure probe, as known from the prior art.

FIG. 1c—prior art shows a static pressure probe which is incidence insensitive, as known from the prior art.

FIG. 1d—prior art shows an alternative static pressure probe which is incidence insensitive, as known from the prior art.

FIG. 2a—prior art shows the multiple sensing ports across a pipe in a multi-port averaging Pitot, as known from the prior art.

FIG. 2b—prior art shows a cross section of a multi-port averaging Pitot, as known from the prior art.

FIG. 3—prior art shows a bi-directional low-velocity differential pressure probe, as known from the prior art.

FIG. 4 shows a differential pressure probe with a truncated elliptical bulbous part according to an embodiment of the present invention.

FIG. 5 shows a differential pressure probe with a partly spherical bulbous part according to an embodiment of the present invention.

FIG. 6 shows a differential pressure probe with a truncated semispherical bulbous part according to an embodiment of the present invention.

FIG. 7 shows a differential pressure probe with a partly conical bulbous part according to an embodiment of the present invention.

FIG. 8 shows a differential pressure probe with a double flow detachment means, according to an embodiment of the present invention.

FIG. 9 is a schematic overview of a hemisphere shell differential pressure probe according to a second embodiment of the present invention.

FIG. 10 is a schematic overview of possible pressure port positions on a hemisphere shell differential pressure probe according to a second embodiment of the present invention.

FIG. 11 is a schematic overview of possible modifications of a hemisphere shell differential pressure probe according to a second embodiment of the present invention.

FIG. 12 is a schematic overview of some differential pressure probe shapes with their corresponding drag coefficient data.

FIG. 13 is a schematic overview of the probes according to embodiments of the present invention and prior art probes used for obtaining experimental results.

FIG. 14a and FIG. 14b are a sectional view (a) and a frontal view (b) of a differential pressure probe according to an embodiment of the present invention, indicating the location of the pressure ports as used for obtaining the experimental results.

FIG. 15 shows a graph indicating a comparison of angular sensitivity between different probes, i.e, a change in kₚ, with respect to zero angle, i.e. when the probe is inline with the flow, according to embodiments of the present invention and prior art probes.

FIG. 16 shows a graph indicating a comparison of angular sensitivity between probes with different semi-spherical bulbous parts, i.e. a change in kₚ, with respect to zero angle, i.e. when the probe is inline with the flow, according to embodiments of the present invention.

FIG. 17 shows a graph indicating a comparison of angular sensitivity between different recess shapes, i.e. a change in kₚ, with respect to zero angle, i.e. when the probe is inline with the flow, according to embodiments of the present invention.

FIG. 18 shows a graph of the probe factor, relating the differential pressure measured with the flow velocity as a function of the Reynolds number (Re).

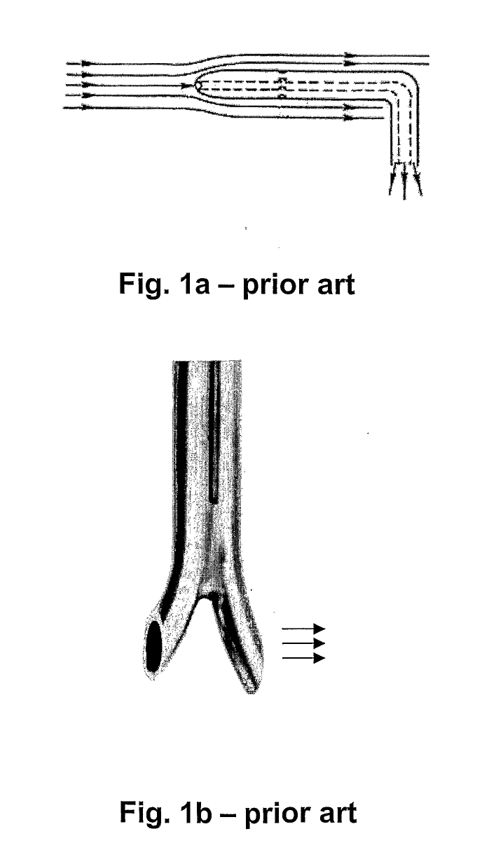

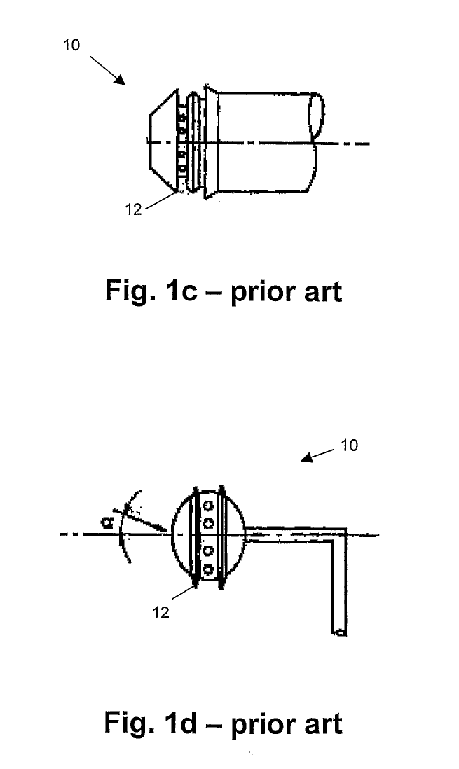

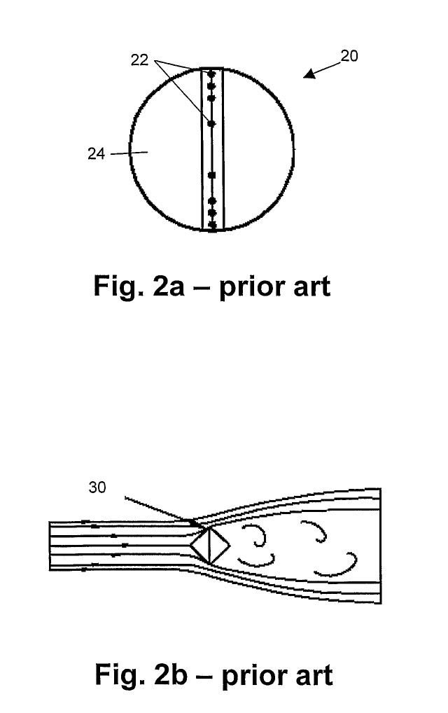

In the different figures, the same reference signs refer to the same or analogous elements.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps Thus, the scope of the expression “a device comprising means A and B” should not be limited to devices consisting only of components A and B. It means that with respect to the present invention, the only relevant components of the device are A and B.

The present invention relates to a flow velocity meter for determining the velocity of an incoming flow of a fluid. The velocity is obtained out of a measure of the differential in pressure between the upstream facing part of the body, and the downstream part of the body.

In a first embodiment, the invention relates to a pressure probe allowing to combine correct pressure measurement with flow angle independency, Reynolds independency and, if two measurements are carried out, with a high differential pressure gain. Several examples of such pressure probes are shown in FIG. 4 to FIG. 8.

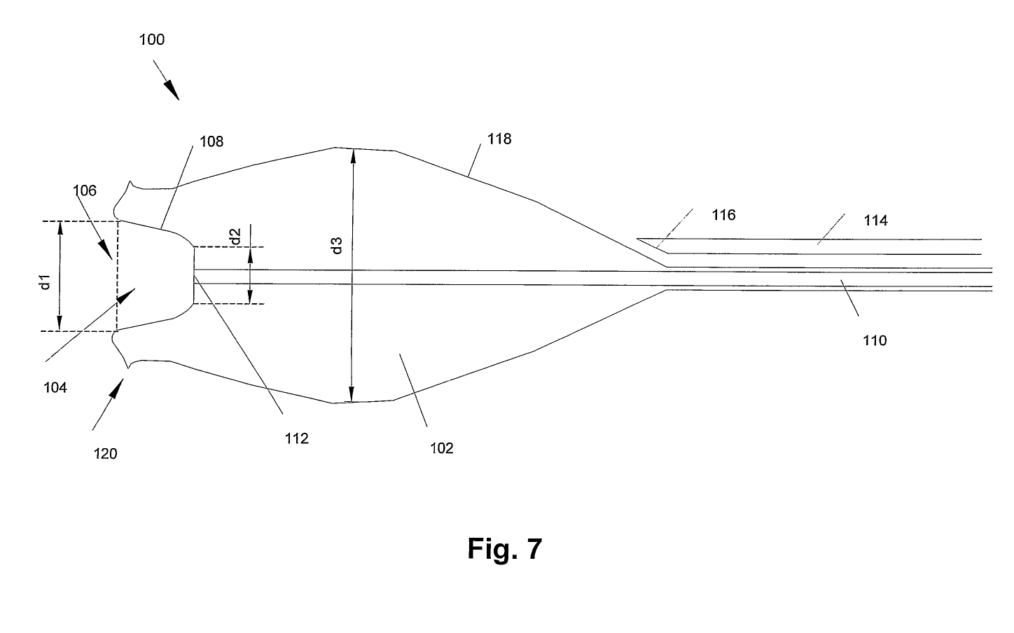

The pressure probe 100 comprises a bulbous part 102 wherein at the front side, facing the flow, either a planar surface or a recess 104 is provided. The recess 104 may be concave. If a recess 104 is present, it has a front opening 106 and a back portion also referred to as inner surface 108. In the embodiment illustrated, the device furthermore comprises two pressure sensing lines, a first one being a high pressure sensing line 110, which has a sensing port 112 in the recess 104 and a second pressure sensing line, being a low pressure sensing line 114 at the back or the side portion of the bulbous part 102, having a sensing port 116 in a region of lower pressure, generated by the pressure probe 100. Alternatively, the pressure sensing ports 112, 116 may be adapted such that local measurements are performed and the pressure sensing lines 110, 114 can be avoided. The port 112 of the high pressure sensing line 110 is located at the inner surface 108 of the recess 104. This may be anywhere at the inner surface 108 of the recess 104. The port 112 of the high pressure sensing line 110 may be positioned such that the sensing port is not in line with the flow direction of the fluid measured. The latter is preferred if there is to be measured in dirty media, as it will prevent that small particles easily block the sensing port 112. Alternatively, the port 112 also may be placed at the centre of the back portion 108, as shown e.g. in FIG. 4. It is expected that the pressure inside the recess 104, especially for a hemisphere recess, is almost constant so that the high pressure sensing port 112 can have any desired location on the recess wall. The high pressure sensing line 110 further may run through the side of the bulbous part 102, as illustrated e.g. in FIG. 4, or may run through the back of the bulbous part 102, as illustrated e.g. in FIG. 7. The pressure sensing lines may widen a bit close to the pressure ports 112 and 116 in order to prevent or diminish e.g. clogging of particulate matter, etc. Although only a single low pressure port 116 and a single high pressure 112 port are shown, the number of pressure ports, both for sensing low and high pressure, may be larger. Furthermore, the number of high pressure ports does not need to be equal to the number of low pressure 10 ports. The system furthermore may be equipped with integrated controlling means to check a failure of any of the pressure ports.

The shape of the surface of the inner surface 108 or back portion 108 of the recess 104 may have any shape, such as for example a partial spherical shape or truncated partial spherical shape, a partial cylindrical shape, a partial ogival shape or truncated partial ogival shape, a partial oval shape or truncated partial oval shape, a partial elliptical shape or truncated partial elliptical shape, a conical or truncated conical shape or a parabolic shape or truncated parabolic shape, or a combination thereof. The recess may be a concave recess. The shape may be such that the largest diameter of the recess 104 is positioned at the opening 106 of the recess 104. Truncation of the surface shape of the back portion 108 of the recess 704, if present, may be performed at the center of the back portion 108 of the recess 104. The truncation preferably is such that the ratio of the diameter d₁ at the opening 106 to the diameter of the truncated side d₂, i.e. typically the minimum diameter of the recess 104, is larger than 2, preferably larger than 3, more preferably larger than 4, even more preferably larger than 6, even more preferably larger than 10. The recess 104 thus is shaped such that for each two diameters, the diameter closest to the front opening 106 is not smaller, preferably larger than the diameter closest to the downstream side. The diameters thereby typically are measured perpendicular to the standard flow direction, i.e. perpendicular to the axis of rotational symmetry. The shape preferably may be such that it is close to a hemispherical shape.

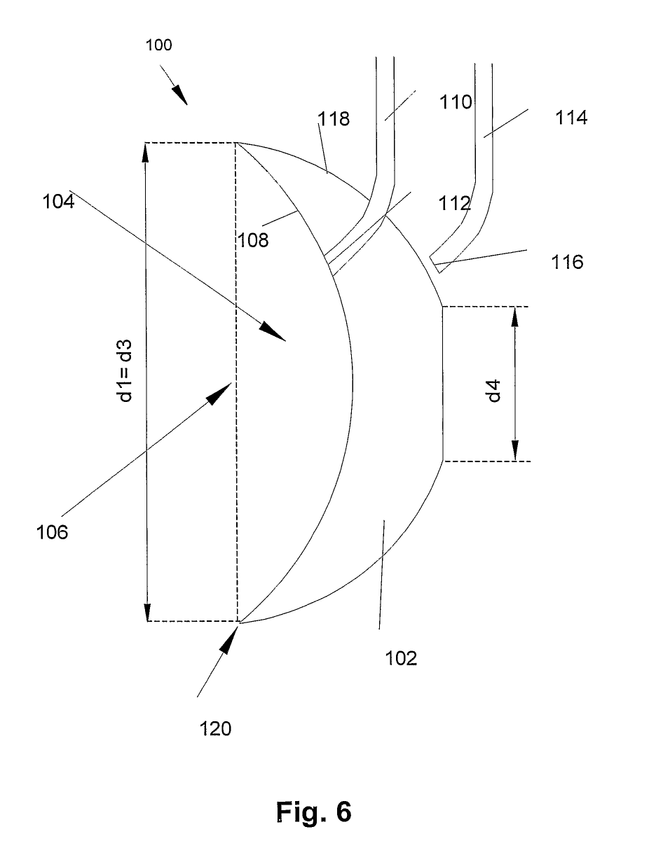

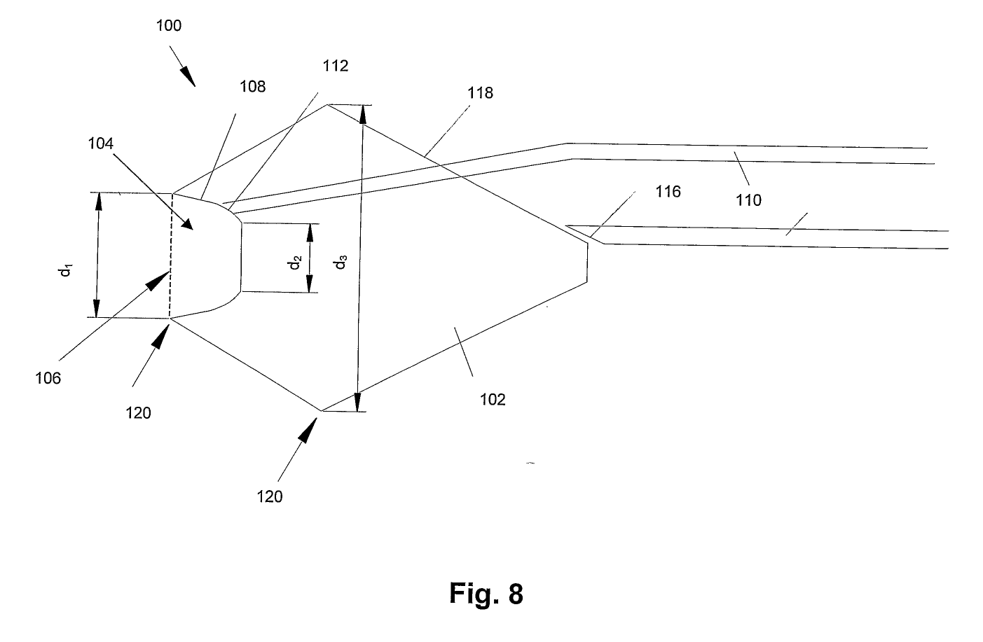

The outer surface 118 of the bulbous part 102 may have a partial spherical, partial cylindrical, partial ogival, partial oval, partial elliptical, partial conical, partial parabolic shape or a truncated version thereof. The shape of the outer surface 118 also may be a combination of these shapes The diameter d₃, i.e. the largest diameter of the bulbous part in the direction parallel to the diameter d₁ of the opening 106 of the recess 104, is such that the ratio of diameter d₃ to diameter d₁ is less than 2, preferably less than 1.5, more preferably less than 1.25. The diameters d₁ and d₃ can be equal, as e.g. shown in FIG. 6. The bulbous part 102 may be truncated at its backside. This truncation, if present such as e.g. shown in FIG. 4, FIG. 6 and FIG. 8, is such that the ratio of the diameter d₄ of the truncated part of the bulbous part 102, to the diameter d₃ may be less than 0.5, preferably may be less than 0.4, more preferably may be less than 0.3 or may be less than 0.1. The probe 100 provides at the side and the back of the bulbous part 102 regions with a lower pressure, also called a wake. In these regions, the port 116 of the low pressure sensing line 114 is provided. The exact position of the low pressure sensing port 116 in the wake is not critical but lies preferably in the vicinity of the body.

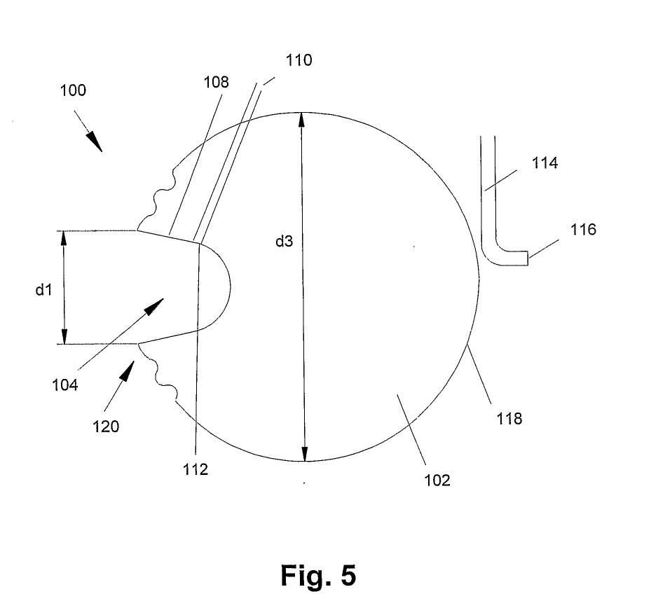

The pressure probe 100 furthermore comprises a means for generating a detachment of the flow 120. This flow detachment means 120 typically may be provided by e.g. an edge, a rim, a rib or a fin or by a roughness on at least part of the outer surface 118 of the bulbous part. The flow detachment means 120 can e.g. be provided by the edge between the surface of the recess 104 and the outer surface 118 of the bulbous part 102, as shown in FIG. 4, FIG. 6 and FIG. 8. Typically, the flow detachment means 120 are provided at a single position with respect to the axis of rotational symmetry of the probe 100. Alternatively, the flow detachment means 120 may be provided by roughness on at least part of the outer surface 118, such as e.g. on the part of the outer surface surrounding the recess 104, as illustrated by way of example in FIG. 5, by dimples such as those known in golf balls, or by edges, preferably sharp edges, in the outer surface 118, as shown in FIG. 7 and FIG. 8. In the cross section shown in FIG. 8, two flow detachment means 120 are shown both at the bottom and at the topside of the cross section. The number of flow detachment means 120 present thus is not limited to a single area. In the case of a cylindrical symmetrical bulbous part and front opening 106, several detachment means 120 distributed in different cylindrical symmetrical areas may be present. The means for flow detachment 120 make the separation points fixed by geometry of the object, irrespective of the flow velocity within a broad range of subsonic velocities This makes the drag coefficient and thus the operation of the pressure probe substantially independent of the Reynolds number. This independency of the Reynolds number is obtained for a range with a lower limit of 2.10⁴, preferably 10⁴, more preferably 5.10³, even more preferably 10³ and an upper limit of 6.10⁴, preferably of 10⁵, more preferably of 10⁶, even more preferably of 10⁷, still even more preferably 10⁸. The Reynolds number thereby is defined as an inherent flow parameter for the pressure probe itself, independent of the environment wherein the flow is measured. The Re number is a dimensionless number that characterises the flow and is a measure of inertia forces compared to viscous forces.

The above-described pressure probes have a specific shape such that the drag coefficient and thus the pressure difference is optimised. The drag coefficient is mainly influenced by the specific shape of the probe itself The positions of the pressure ports 112, 116 are less relevant. Increasing the drag may also be realised by introducing vents in the sidewall of the probe The influence of the shape is illustrated for some probe shapes in FIG. 12. Thereby only rotational symmetrical objects are discussed, for a maximum angular insensitivity is envisaged. Furthermore only objects with a drag coefficient CD larger than one are considered since the aim is to increase the drag or differential pressure with respect to the Pitot-static tube.

The invention can be realized in a wide variety of materials like plastics, metals, ceramics, etc. and can be treated with coatings etc. This makes the invention suitable for use under a wide variety of physical (both high and low temperature/pressure/ . . . ) and chemical (acids, radioactive products, . . . ) conditions. It also can be used in circumstances where the fluid contains impurities (dust, soot, sand, oil, . . . ). Its angular insensitivity makes it particularly useful in those applications where the incidence angle may vary. It also reduces installation costs since no accurate alignment is needed any longer. Its limited size makes that for installation in pipes only one hole limited in size needs to be drilled Its shape is suited to be produced as a mass product at a cost that is only a fraction of other existing solutions. This opens the door to the use in applications where cost is a limiting factor. Also in the field of servicing industrial equipment it is easier to replace the product with a new one than to inspect the old one, clear it and possibly recalibrate it. The head losses related to the drag of the probe are negligible for most applications. They are much smaller than for most common probes such as the Annubar® probes and similar probes and the losses are even only a fraction of the losses caused by a venturi, a nozzle or an orifice. In the specific case of air, the probes can be used well for low velocities between 1/s and 100 m/s but are not limited to that range. For velocities below 1 m/s (air at sea level) approximately, the probes need to be calibrated as function of the Reynolds number. For velocities above 100 m/s (air at sea level) air no longer can be treated as being incompressible and the influence of the Mach number becomes apparent and needs to be taken into account. The differential pressure that would be obtained using a Pitot-static tube at 1 m/s is 0.59 Pa (air, T-298K, p=101325 Pa, p=1.18 kg/m³). The probes of the present embodiment allow a positive differential pressure gain of more than 30%, preferably more than 40%, more preferably more than 44%, even more preferably more than 48%, still more preferably 50% compared with the Pitot-static tubes. The probe factor thereby is large and substantially independent of the Reynolds number (Re) within a range of Re numbers having a lower limit of 2.10⁴, preferably 10⁴, more preferably 5.10³, even more preferably 10³ and an upper limit of 6.10⁴, preferably of 10⁵, more preferably of 10⁶, even more preferably of 10⁷, still even more preferably 10⁸. With large it is meant that the probe factor is larger than 1.18, preferably larger than 1.2, more preferably larger than 1.22, whereas with substantially independent it is meant that the probe factor only changes 10%, preferably only 6%, more preferably only 4%, even more preferably only 3%, still even more preferably only 2%. Furthermore, the probes of the present embodiments show a very good insensitivity to angular distortions for ranges significantly larger than +5°. The shift in the probe factor kₚ, is less than 5%, preferably less than 2.5%, more preferably less than 1.5% for flow directions making an angle with the standard incident direction of up to 5°, preferably of up to 10°, more preferably of up to 15°, even more preferably of up to 20°, still more preferably of up to 23°. This is advantageous as angular distortions lead to a bias on the measurement results and therefore should be avoided at any time. Avoiding these angular distortions nevertheless is not always possible, certainly not for small deviations from the probe's zero position. The invention has led to a surprisingly good combination of large flow angle insensitivity, large pressure gain, a large Reynolds number independency and the ability to use the probe in a wide variety of fluids, even if small particles are present in the fluid.

The device furthermore typically may comprise measurement means for measuring the differential pressure between the high pressure sensing port 112 and the low pressure sensing port 116. Typical means that can be used are e.g. pressure transducers, manometers, etc, although the invention is not limited thereto. The system furthermore may comprise a sensor for measuring the temperature of the fluid. The system furthermore may comprise standard electronics or a computing means for determining the flow rate information for the fluid or for different components of the fluid if computing means are used, these may be any conventional computing means such as a microprocessor, a microcomputer, an ASIC, an FPGA, a PAL, a PLA or the like. Alternatively, these means can be provided separately.

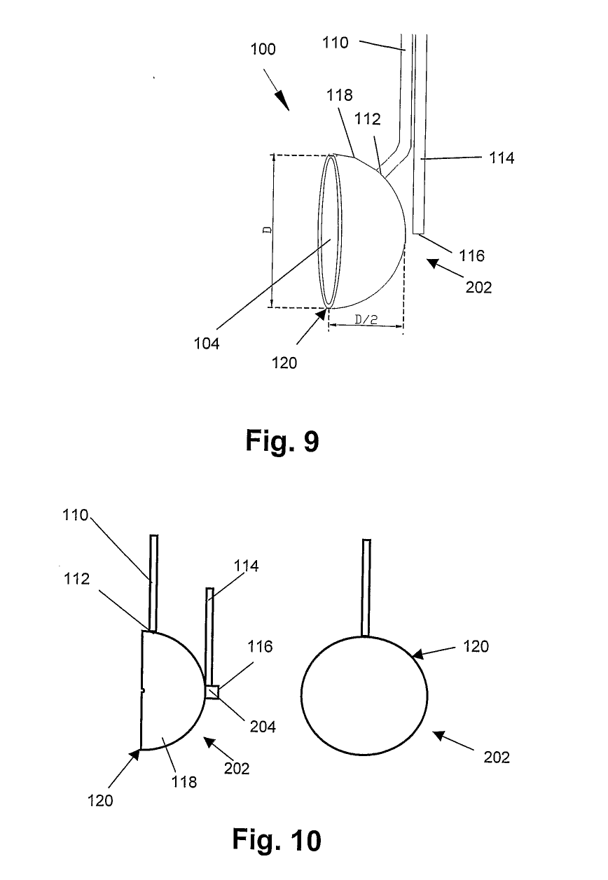

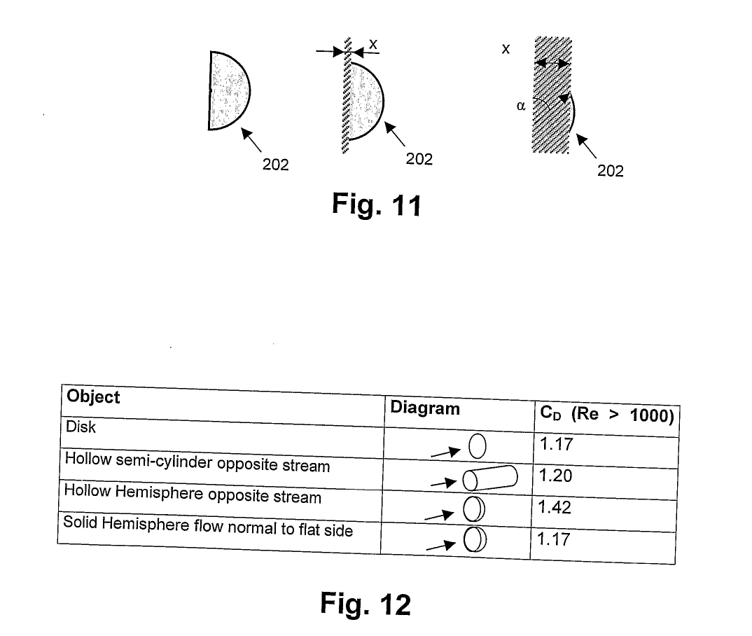

In a second embodiment, the present invention relates to a pressure probe having a front side, adapted to face upstream, and a spherical shaped bulbous part 202. Examples of these probes are shown in FIG. 9, FIG. 10 and FIG. 11. The spherical shaped bulbous part 202 has an outer surface 118 that either can be a sphere or part thereof. Typically the outer surface 118 can be half a sphere, the device then being referred to as a hemisphere, can be a partial sphere being larger than half a sphere, the device then being referred to as a positively extended hemisphere, or can be a partial sphere being less than half a sphere, the device then being referred to as a negatively, cut hemisphere The extended hemisphere and the cut hemisphere thus can be seen as a hemispherical shape whereby at the front side respectively a part is added or a part is cut off. The latter is illustrated in FIG. 11, hereby a part with width x is removed from the hemisphere to obtain a cut hemisphere. The angle α, referred to the positive x-axis as indicated in FIG. 11, thus expresses, the amount of cut off of the spherical part. For a hemisphere, i.e. half of a sphere, the angle α=0°, for a cut hemisphere, the angle α>0° and for an extended hemisphere, the angle α<0°.

The spherical shape of the bulbous part 202 provides specific advantages for flow angle insensitivity, Reynolds independency, good operation in dirty media, etc. The latter is illustrated by tests described below, comparing the spherical shaped probe with other probes according to the present invention and with prior art probes.

The pressure probe 100 furthermore comprises at the front side of the spherical bulbous part 202, facing the flow, either a planar surface or a recess 104. The front side preferably may comprise a hemispherical recess. Furthermore at-least one high pressure sensing port 112 and at least one low pressure sensing port 116 may be present. The recess 104, and the pressure sensing ports 112, 116 may have all features of the recess 104 as described in the first embodiment. FIG. 9 and FIG. 10 indicate different possible positions for the high pressure sensing port 112. The low pressure sensing port 216 typically is positioned at the back or the side portion of the spherical bulbous part 202 such that it has a sensing port 116 in a region of lower pressure, created or influenced by the spherical bulbous part 202, i.e. in the wake of the body. The actual position of the lower pressure port in the wake of the body is less important. Turning the probe with respect to the incoming flow will however influence this wake. Because of symmetry reasons, the lower pressure port preferably lies on the axis of symmetry of the probe. In a specific design, the lower pressure sensing line may comprise a small cylinder 204 welded on the back side of the hemisphere, as shown in FIG. 10. The tube of the high pressure sensing port, and/or the tube of the low pressure sensing port may be used to support and position the pressure probe in the flow. Alternatively, another means for supporting and positioning the device may be provided and the pressure sensing ports, especially the low pressure sensing port may be separate from the bulbous part of the pressure probe. The pressure probe furthermore may comprise a means for generating a detachment of the flow 120, to detach the flow from the spherical bulbous part 202. The flow detachment means 120 may be similar to the flow detachment means described for the first embodiment, comprising similar features and characteristics.

Depending on the shape of the outer surface 118, the probe constant, which is a measure for the optimum differential pressure gain that can be obtained, decreases when the front side of the hemisphere is reduced, i.e. α>0. While extending the front side of the probe towards a sphere i.e. for α<0, the drag coefficient is presumed to first further increase, i.e. for small absolute values of α, whereas for larger absolute values of α the drag coefficient will further decrease, to reach a minimum for a near about −37° in case of a planar surface front side, and the probe will become Reynolds dependent from the moment that the flow no longer separates from the probe at the sharp front side.

For a hemispherical shell probe, having a recess in the shape of half a sphere, the obtained angular sensitivity is large. The angular sensitivity remains more or less the same in the range +20° to −20° and drops only significant outside the range +30° to −30° range. Probes that have a front surface that is flat or probes with a recess having another shape also can be used. A significant Reynolds number (Re) independency can be obtained, i.e. for a range having a lower limit of 2.10⁴, preferably 10⁴, more preferably 5.10³, even more preferably 10³ and an upper limit of 6.10⁴, preferably of 10⁵, more preferably of 10⁶, even more preferably of 10⁷, still even more preferably no upper limit. The differential pressure gain that can be reached is about 30%, preferably about 40%, more preferably about 44%, even more preferably about 48%, still more preferably 50% of the differential pressure gain of the Pitot-static tube.

An advantage of the spherical outer surface 118 is that the outside probe diameter can be limited, which allows an easier mounting of the device. Furthermore, the hemisphere probe can easily be made in a wide variety of materials like plastics, metals, ceramics, etc. It can also easily be treated with special coatings etc. that make it suitable for use in a wide range of fluids. Similar features as described in the previous embodiment may thereby be provided. Its shape is suited to be produced as a mass product at a cost that is only a fraction of other existing solutions. This opens the door to the use in applications where cost is a limiting factor. Also in the field of servicing industrial equipment it is easier to replace the product with a new one than to inspect the old one, clean it and eventually recalibrate it. The angular insensitivity makes it easy to install since accurate positioning is no longer crucial. Installation in pipes only requires drilling one hole, which can be limited in size. Although the head losses related to the drag of the probe are higher than for most Pitot tubes, they are much smaller than for the averaging Pitots such as the Annubar® probe, and only a fraction of the losses caused by a venturi, a nozzle or an orifice. Furthermore, due to the relatively large impact opening of the hemispherical shell and similar probes, these are effective in fluids containing other components like e.g. clogging particles, soot, dust, impurities, etc.

Several tests have been performed to check and compare the properties of the pressure probes according to embodiments of the present invention and prior art probes. The tests have been performed in two low speed wind tunnels. The first wind tunnel used, available e.g. at the ELIS department of Ghent University, is an open circuit wind tunnel of the suction type. It incorporates an air inlet, fitted with honeycomb and meshes, a two dimensional contraction and a test section of 500 mm height by 600 mm width. Velocity can range from 0.3 m/s to 4.3 m/s. The turbulence level varies from 1.3% for the highest velocities to 2% for velocities around 1 m/s and increases significantly for velocities below 0.9 m/s. The wind tunnel is calibrated by means of Laser Doppler Anemometry. The pressure measurements are made by a highly sensitive transducer with a range from 0 to 20 Pa. In this example, a Druck LPX9481 transducer having an accuracy of 0.02 Pa is used. The second wind tunnel used, available e.g. at the Fluid Mechanics department of Ghent University, is a closed circuit wind tunnel. Looking downstream the test section, it incorporates a diffuser, two contra-rotating axial fan blades, a diffuser, a honeycomb followed by a settling chamber, a contraction and a test section of 446 mm height by 180 mm width. Maximum flow speed is 40 m/s. The second wind tunnel is calibrated by means of a Pitot-static tube with an outside diameter of 4 mm. Based on experimental set-up considerations, the measurements were taken in a range from 3 m/s to 40 m/s. The pressure measurements for this windtunnel are done with two pressure transducers, a first ranging from 0 to 250 Pa, with an accuracy of 0.1 Pa between 0-120 Pa and an accuracy of 1 Pa between 120-250 Pa and a second ranging from 0-1250 Pa, with an accuracy of 12.5 Pa. In the given example, a Halstrup P92 transducer and a Barotron transducer are used as first and second pressure transducers respectively.

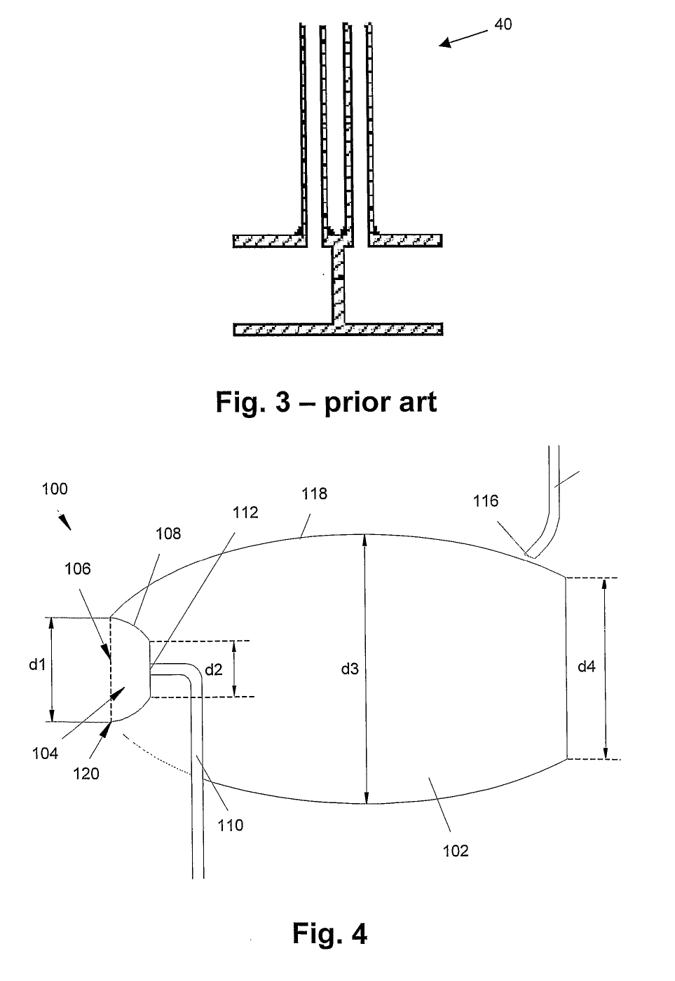

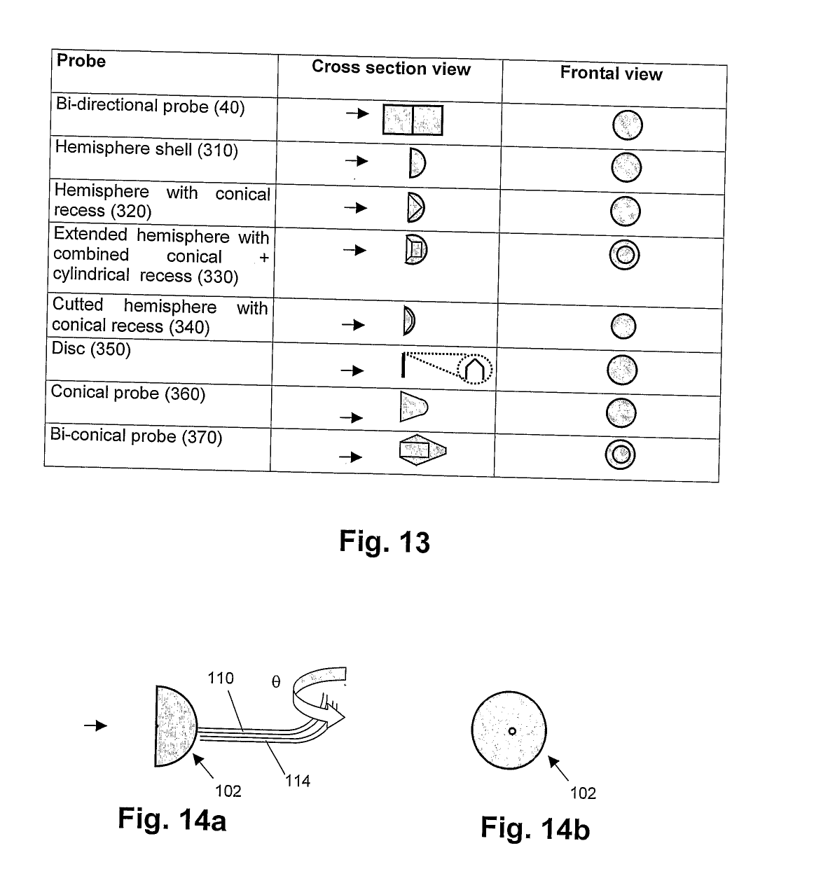

By way of example, a total of 8 probes have been fabricated to compare, the probes having a rotational symmetry, i.e. being cylindrical symmetrical, having a drag coefficient larger than 1, having sharp edges as flow detachment means and having a simple and robust design. An overview of the section view and the frontal view is shown in FIG. 13. The probes tested are a Bi-directional probe 40, as known from the prior art and shown in FIG. 3, a hemisphere shell 310, where both the outer surface 118 and the inner surface are hemispheres, a hemisphere with conical recess 320, a positively extended hemisphere with a combined conical and cylindrical recess 330, whereby the outer surface 118 is a partial sphere, being larger than half a sphere, a negatively cut hemisphere with conical recess 340, whereby the outer surface 118 is a partial sphere, being smaller than half of a sphere, a disc 350, a conical probe 360 and a bi-conical probe 370. The positively extended hemisphere has an angle α, as described in the second embodiment, of −50°, while the negatively cut hemisphere has an angle α, as defined in the second embodiment, of 12°. The tested cone probe is a cone with an angle of 18° with respect to the probe axis and the bi-conical probe has an upstream cone with an angle of 22° with respect to the probe axis and a downstream cone with an angle of 29° with respect to the probe axis. All high-pressure measurements are taken centrally through the back part (right hand side) of the instrument except for the bi-directional probe 40, known from the prior art. All lower pressure measurements are taken at the back of the probes just underneath or above the higher-pressure conduit, as indicated in FIG. 14a in side view. By way of example and to obtain a significant confidence level of the acquired data, the data acquisition for all data is based on the mean value of 300 consecutive measurement samples taken at a scan rate of 10 Hz. The data acquisition system used is a Keithley 2700/7702 Multimeter based on the Integrating A/D principle. The integration process works as a low pass filter with—with the integration time set to 20 ms (one power line cycle)—a cut-off frequency (−3 dB) of 22 Hz. All measurements have been corrected for bluff-body blockage, as described e.g. by Cooper in “Bluff-Body Blockage Corrections in Closed- and Open-Test-Section Wind Tunnels p AGARD-AG-336 (1998, edited by B. F. R. Ewald). This correction takes into account that any bluff body placed in a stream modifies this stream. All electronics are switched on at least one hour prior to taking the first measurements. The pressure transducers where zeroed prior to the first measurement of the day.

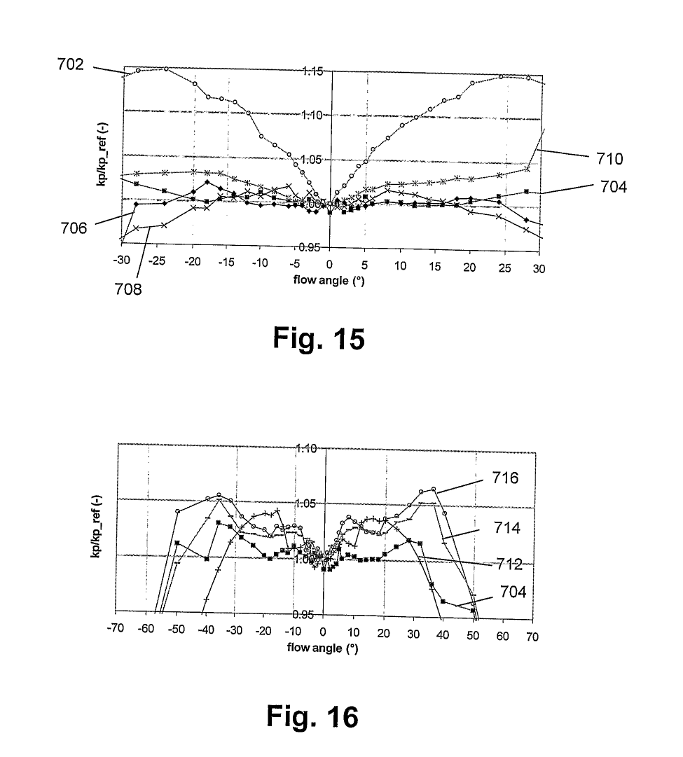

FIG. 15 and FIG. 16 indicate the test results for flow angle dependency for several tested probes, described in FIG. 13. By way of example, test results are shown for different angles of incidence θ for the probes at an air speed of about 4.1 m/s. The measured standard deviation is 0.05 m/s and the turbulence intensity is 1.3%. The selection of the air speed is based on the expected Reynolds numbers when running fire tests according to EN13823, which is a European Standard on Reaction to fire tests for building products—Building products excluding floorings exposed to the thermal attack by a single burning item, as published by the CEN Central Secretariat, Brussels 2002. The experiment has been repeated for the hemisphere probe at a velocity of 8 m/s with similar, even more stable results. In FIG. 15 the angular sensitivity of different probe designs together with the bi-directional probe 40 are set out. The figure displays the square root of the ratio of the differential pressure measured over the probe at an incidence angle θ and the differential pressure at θ=0, i.e. kₚ(θ)/kₚ(θ=0) (M<<1). It can be seen from this figure that for small angular variations the velocity—which is proportional to the square root of the differential pressure for incompressible fluids—measured by the bi-directional probe 40, indicated by curve 702, increases with roughly 1% per degree, initially. This is a high number so much the more because small angular variations due to misalignment or due to flow effects can often not be excluded. Both the hemisphere shell 310, indicated by curve 704, and the bi-conical probe 370, indicated by curve 706, have excellent results in the range from −15′ to 15°. In this range the error on the derived velocity stays in the 5% interval, preferably the 3% interval, more preferably the 2% interval, still more preferably the 1.5% interval for both of them. For the hemisphere shell 310, i.e. curve 704, the range with an error on the derived velocity limited to 1.5%, is at least extended to −20° to +20° Furthermore, in the range from −45° to 45° the error remains limited to 5%. Outside that range, the differential pressure drops fast and the exact location of the low-pressure port becomes predominant. By tuning the exact location of the low pressure port and further optimising the hemisphere shell probe 310, the insensitivity range for the flow angle dependency may even be further enlarged. The steep fall in pressure or any other characteristic part of the graph of any of the probes presented may be used to derive the flow direction. The disc probe 350, indicated by curve 708, and the conical probe 360, indicated by curve 710, are included for comparative reasons. It can be seen that for a disc probe 350, which is a limit case of an adjusted hemisphere shell—adjusted by reducing the front side—the error for the derived velocity slightly increases to less than 2%, but that the angular insensitivity remains relatively good. The latter suggests that, with respect to the flow angle independency, any shape between the hemisphere shell 310 and the flat disc 350 results in acceptable probes. In other words, the angular sensitivity probe characteristics hardly change for modified hemisphere probes as described in the second embodiment. There are indications that the flow angle independency can even be further extended for slightly positively extended hemispheres. As an example, FIG. 16 shows the results for a strongly positively extended hemisphere 330 probe, indicated by curve 712, with an angle α=−50°, i.e. with an outer surface 118 being partly spherical, the partial spherical shape being larger than half a sphere, compared to probe designs where the angle α=0°, i.e. the hemisphere shell 310 indicated by curve 704 and the hemisphere with conical recess 320 indicated by curve 716, and a negatively cut hemisphere 340 having an outer surface 118 which is partly spherical, partly spherical being less than half a sphere, i.e. with an angle α=12°, indicated by curve 714. The angular sensitivity remains more or less the same in the range +20° to −20°. Outside the range +30° to −30° range the differential pressure over the probe drops faster. In the limit of approaching a sphere, i.e. where α=−90°, the probe will become more sensitive to angular variations, as is known from e.g. Fox R. W, and McDonald A. T., in “Introduction to fluid mechanics”, published by Wiley (1985).

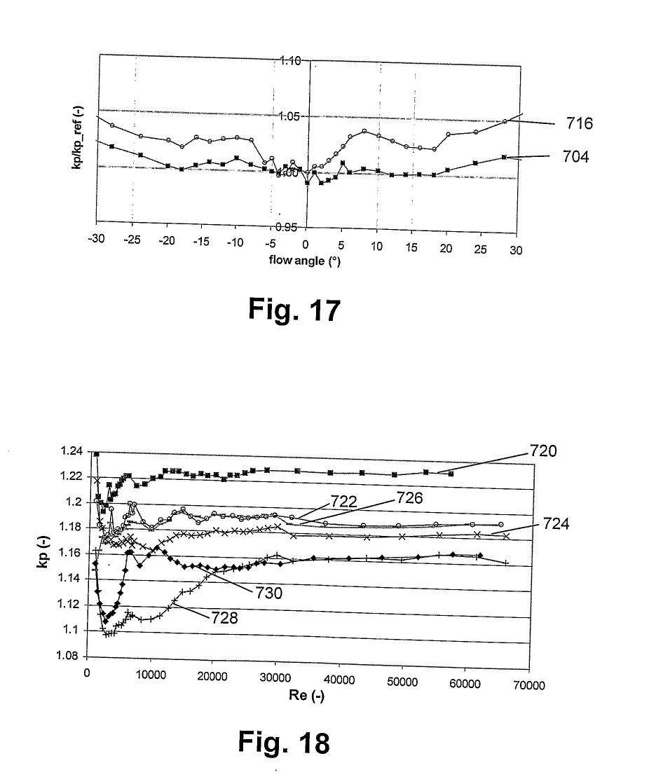

The possible effect of modifying the recess, which provides the inlet for the pressure probe is investigated by comparing two hemisphere probes with either a spherical inlet, thus defining a hemispherical shell probe 310 for which the results are indicated by curve 704, or a hemisphere with a conical inlet 320, for which the results are indicated by curve 716. FIG. 17 shows that although the error remains limited to 5% in a range between +25° and −25°, there is a clear negative influence modifying the inlet from hemispherical to conical.

The probe with the conical shape 360 is more sensitive to angular variations than the hemisphere probe 310. It is therefore excluded from any further discussion.

The bi-conical probe 370 on the other hand has good behaviour in the range ±150 and even up to ±25°. It is believed that there is still room for improvement of this probe by optimising the conical shape of the upstream cone, modifying the inlet shape and optimising the shape of the downstream cone, eventually omitting it.

In a second test the probes are calibrated in air as function of the Reynolds number in a velocity range from 1 to 40 m/s. In this velocity range air can be considered as being incompressible. Although for lower Reynolds numbers the probe factor is function of Re, it will farther be referred to as probe constant kₚ, which is defined as

$${k}_{p} = \sqrt{\frac{Δ p}{{p}_{tot} - {p}_{stat}}} = \sqrt{\frac{Δ p}{\frac{1}{2} {pv}^{2}}} = f ( Re ) \qquad [ 2 ]$$

for incompressible flows Often air is considered to be an incompressible 30 Newtonian fluid for Mach numbers below 0.3. In practice, other fluids are also treated as being incompressible where possible Pitot-static probes can be designed such that the probe factor kₚ is 1 for Re>200 and M<0.85 or even higher Mach numbers.

FIG. 18 displays the probe constant as a function of the Reynolds number related to the outside diameter D of the probe. The Reynolds number is 5 defined as

$$Re = \frac{ρ . v . D}{μ} = \frac{v . D}{v} \qquad [ 3 ]$$

and is a measure of the ratio of inertia forces to viscous forces μ thereby is the dynamic viscosity, ν the kinematical viscosity, v the flow rate and ρ the density of the fluid. The measurement results show that the hemisphere shell 310, the results being indicated by curve 720, has a measured constant probe factor as high as 1.22 to 1.23 for Reynolds numbers above 10 000. This corresponds to a differential pressure gain of around 50% with respect to a Pitot-static tube. The probe can be used at lower Reynolds numbers but then requires calibration. The results obtained so far suggest that the probe factor first decreases to 1.20 for Re=2000 after which it begins to rise to high numbers (1.43 at Re=42°; the 95% confidence interval is however in the order of 20% in this point). This is when friction forces become more important and their effect on the drag no longer can be neglected. Changing the inner shape of the probe from spherical to conical, i.e. probe 320, reduces the probe factor with approximately 3% to 1.195, as indicated by curve 722, which makes that the differential pressure over the probe reduces with some 6%. A similar Reynolds number dependency as for the spherical inlet is present for the conical inlet for Reynolds numbers below 10 000. Further filling up of the inlet with solid material, only leaving an opening for the pressure port, will result in a probe factor similar to, but not equal to, the disc 350 design, the results being indicated by curve 724. The probe constant for the disc 350 Lies around 118 which is already 4% lower then for the hemispherical shaped inlet and implies a drop in pressure difference of about 8%. The results also suggest that the probe constant decreases when reducing the front side of the hemisphere i.e. α>0, the results being indicated by curve 726. For α<0, the probe constant initially increases further, but after reaching a maximum, the probe constant drops and the probe will become Reynolds dependant from the moment that the flow no longer separates from the probe at the sharp front side. This can be observed in FIG. 18 for the positively extended hemisphere 330 with conical shaped recess, the results being indicated by curve 728. A Reynolds dependence is not favourable for a pressure probe since it requires corrections to be introduced. The positively extended hemisphere 330 design also results in a lower probe factor. Finally the bi-conical probe 370 design has a probe factor of around 1.17, indicated by curve 730. At first view the design is stronger Reynolds dependant than the hemisphere design especially for Reynolds numbers below 10 000. It is expected however that the design can further be optimised (higher probe factor; less Re dependent), e.g. by skipping the second downstream conus and by increasing the α₁ angle.

The behaviour of the above described probes in “dirty media” plays an important role as e.g. small particles, which may be transported by a media, can block the pressure port, which results in erroneous measurements. The position of the pressure ports plays an important role in this respect. If the pressure ports are placed perpendicular to the main stream flow, particles do not tend to block the pressure port. As described in the above embodiments of the present invention, therefore the total pressure port is positioned such that it is not in the main stream flow, but preferably as much as possible, makes an angle with the main stream flow. The pressure port thus is positioned preferably substantially perpendicular to the main stream flow, i.e. with its cross-section parallel to the main stream flow. In this way, in case the probe axis is placed horizontally and the pressure port is positioned substantially on the upper side of the probe, deposits would drop out even more easily then in the case of the bi-directional probe 40. The bi-conical probe 370 is less suited for use in ‘dirty’ media since deposits cannot drop out easily unless the inner shape would be designed accordingly, i.e. as a converging cone or having a spherical shape. The latter will influence both the angular sensitivity and the probe factor. Another disadvantage is that for a same inner probe inlet diameter as for the hemisphere, a much higher characteristic probe diameter (largest diameter of the probe) would be needed.

The position of the lower pressure port on the hemisphere probe lies preferably on the downstream probe axis. Eventually the lower pressure could, in analogy with the bi-directional probe 40, be taken from a small open cylinder welded on the backside of the hemisphere. As a general remark; when a purging system is carefully designed, pressurised air can be used to keep pressure ports clean. However, care should be taken that sensitive pressure transducers do not get damaged or get out of calibration due to purging.

Another important aspect of the pressure probes according to the present invention is their low design complexity and their competitiveness The probes of the present invention, and especially the hemispherical probes, can easily be made in different materials and at a low cost The shape is such that installation is straightforward and the angular independency eliminates the need for fine tuning during installation.

An overview of the characteristics of the prior art pressure probes and some examples of pressure probes according to the present invention is given in Table 1. The results refer to the angular insensitivity, the pressure gain, the Reynolds independency, the expected behaviour in dirty media and the design complexity of the different pressure probes. The differential pressure gain given is with reference to a Pitot-static tube. The angular insensitivity is expressed as the limiting angle in which interval the error on the square root of the differential pressure remains limited to 1% respectively 2%. It is to be noted that the experimental results for the angular sensitivity of the Bi-cone are described whereby a peak around −18° was omitted as no peak was measured around +18°.

TABLE 1

| | Angular | Re | Db | | | | |
|---|---|---|---|---|---|---|---|
| | Insensitivity | insensitivity | pressure | Head | | | ‘Dirty’ |
| Probe | 1%/2% (±°) | (Re > 10 000) | Gain (%) | Losses | Size | Simplicity | Media |
| Bi-directional | 1/2 | ++ | 11 | ++ | ++ | 0 | ++ |
| Hemisphere Shell | 23/30 | ++ | 51 | ++ | ++ | ++ | ++ |
| Hemisphere with | 4/6 | ++ | 43 | ++ | ++ | 0 | ++ |
| conical recess | | | | | | | |
| Extended Hemisphere | 2/7 | −/0 | 37 | ++ | ++ | 0 | 0 |
| with conical recess | | | | | | | |
| Cutted Hemisphere | 4/12 | ++ | 43 | ++ | ++ | 0 | + |
| with conical recess | | | | | | | |
| Disc | 5/25 | ++ | 39 | ++ | ++ | ++ | − |
| Bi-cone | 15/28 | 0/+ | 37 | ++ | ++ | + | + |
| | (27)^{(b)}/28 | | | | | | |

The device of the invention may be used, on the one hand, as a fixed probe, e.g. for measuring the velocity of the medium which flows around the probe and, on the other hand, as a moving probe, for example on flying bodies, ships, land vehicles or the like while they move through a medium, for example air or water, to measure the relative velocity between the body carrying the probe and the medium. In the latter case, the probe is used to measure the velocity of the moving object.

The embodiments of the present invention preferably have a rotational symmetrical shape so that the angular insensitivity obtained is with respect to the axis of symmetry, whether it be a pitch angle or yaw angle deviation.

The devices and methods described in the above embodiments can be used amongst others in all applications where fluids are transported through pipes such as in e.g. chemical, petrochemical industry and pharmaceutical industry or where fluids flow in chimneys or other pipes evacuating combustion gasses, in meteorology, aviation, aerospace, shipping, transport, measurement of motion in helicopters, fluid movement in tunnels, measuring of flow movements in buildings such as e.g. smoke movements for fire safety or air movement for air-conditioning, etc. In other words: all applications where pressure and/or differential pressures, to for example obtain fluid flow or motion of objects relative to fluids, need to be measured make up the potential market. It is an advantage of the present invention that the devices are not limited to measurements in a pipe. In order to measure a flow rate in pipes, instead of applying a velocity profile correction factor, sensing total and static pressures can also be performed at different specific heights in a duct.

It is to be understood that although preferred embodiments, specific constructions and configurations, as well as materials and applications, have been discussed herein for devices according to the present invention, various changes or modifications in form and detail may be made without departing from the scope and spirit of this invention.

1. A pressure probe for characterising pressure in a fluid, the probe comprising:
a front side adapted for facing an upstream direction of said fluid flow for creating a region of high pressure, said front side being planar or comprising a recess,
a flow detachment means, and
a bulbous part adapted for creating, in co-operation with said flow detachment means, a region of low pressure.

2. The pressure probe according to claim 1, the fluid having a flow direction, there being an angle included between the flow direction and a direction perpendicular to the front side of the device, wherein for every angle between +30° and −30′, preferably between +40′ and −40°, more preferably between +50° and −50° the characterised measured pressure difference of said fluid flow differs less than 10%, preferably less than 5%, with respect to the measured pressure difference for a flow direction being said perpendicular direction.

3. The pressure probe according to any of claim 1, the bulbous part having an outer surface, wherein at least part of said outer surface has a rotational symmetrical shape.

4. The pressure probe according to claim 3, the outer surface having a radius of curvature, wherein the radius of curvature of the outer surface is smaller than 100 times the maximum diameter of said probe measured perpendicularly to the rotational symmetry axis of the probe, preferably smaller than 10 times said maximum, even more preferably smaller than 5 times said maximum diameter, still more preferably smaller than 2 times said maximum diameter.

5. The pressure probe according to claim 3, wherein said bulbous part furthermore comprises a planar back side, adapted for facing downstream direction of said fluid flow.

6. The pressure probe according to claim 5, wherein said planar back side has a diameter (d₄) in the direction perpendicular to said axis of rotational symmetry, such that the ratio of said diameter (d₄) of the planar back side of the bulbous part to the maximum diameter (d₃) of the bulbous part is smaller than 0.5, preferably smaller than 0.3.

7. The pressure probe according to claim 3, wherein the length of the probe in the direction of the rotational symmetry axis of the probe is at least 0.05 times the maximum diameter (d₃) of the probe measured perpendicularly to the rotational symmetry axis of the probe and is smaller than 3 times the maximum diameter (d₃) of the probe measured perpendicularly to the rotational symmetry axis of the probe, preferably smaller than 2 times said maximum diameter (d₃), even more preferably smaller than 1 time said maximum diameter (d₃).

8. The pressure probe according to claim 3, wherein said at least part of said outer surface has a spherical shape, partly spherical shape, a semi-spherical or truncated semi-spherical shape, a partial cylindrical shape, a semi-oval or truncated semi-oval shape, a semi-elliptical or truncated semi-elliptical shape, an ogival or truncated ogival shape, a conical or truncated conical shape or a parabolic or truncated parabolic shape, or any combination thereof.

9. The pressure probe according to claim 1, wherein said front side comprises a recess having an inner surface that has a rotational symmetrical shape.

10. The pressure probe according to claim 9, wherein said inner surface has any of a semi-spherical or truncated semi-spherical shape, a partial cylindrical shape, a semi-oval or truncated semi-oval shape, a semi-elliptical or truncated semi-elliptical shape, a conical or truncated conical shape or a parabolic or truncated parabolic shape, ogival or truncated ogival shape, or any combination thereof.

11. The pressure probe according to claim 3, wherein said outer surface has a spherical shape, partly spherical shape, a semi-spherical or truncated semi-spherical shape, a semi-oval or truncated semi-oval shape, a semi-elliptical or truncated semi-elliptical shape, an ogival or truncated ogival shape, or a parabolic or truncated parabolic shape, or any combination thereof.

12. The pressure probe according to claim 11, wherein said outer surface has a hemispherical shape.

13. The pressure probe, according to claim 12, wherein said inner surface has a spherical or partly spherical shape, such that a spherical or partly spherical shell is formed.

14. The pressure probe according to claim 9, the rotational symmetrical shape having an axis of rotational symmetry, wherein said recess has a first maximum diameter (d₁) and said bulbous part has a second maximum diameter (d₃) in a direction perpendicular to said axis of rotational symmetry, such that the ratio of the second maximum diameter (d₃) to said first maximum diameter (d₃) is smaller than 2, preferably smaller than 1.5, more preferably smaller than 1.25.

15. The pressure probe according to claim 14, wherein said recess furthermore has a planar back with a minimum diameter (d₂), such that said ratio of said first maximum diameter (d₁) to said minimum diameter (d₂) is larger than 2, preferably larger than 3, more preferably larger than 4, even more preferably larger than 6, still more preferably larger than 10.

16. The pressure probe according to claim 1, wherein said means for flow detachment is any of an edge, a rim, a rib, a fin or a surface roughness.

17. The pressure probe according to claim 1, wherein said probe further comprises at least one high pressure sensing port in said front surface.

18. The pressure probe according to claim 1, wherein said probe further comprises at least one low pressure sensing port in said region of low pressure.

19. The pressure probe according to claim 18, wherein said probe further comprises a means to sense a pressure difference between said at least one high pressure port and said at least one low pressure port.

20. The pressure probe according to claim 1, wherein said probe further comprises a means for determining a relative flow rate of the fluid.

21. The pressure probe according to claim 20, wherein said probe further comprises a means to determine a relative flow rate of the fluid from said pressure measurement.

22. The pressure probe according to claim 17, the fluid flow having a flow direction, wherein said at least one high pressure port has a cross-section that is oriented substantially parallel with the flow direction of the fluid flow.

23. The pressure probe according to claim 1, having a probe factor kₚ, defined as
$${k}_{p} = \sqrt{\frac{Δ p}{{p}_{tot} - {p}_{stat}}}$$
with Δp the differential pressure measured over the probe, Pₜₒₜ the total 5 pressure and Pₛₜₐₜ the static pressure of the flow, is larger than 1.18, preferably larger than 1.20, even more preferably larger than 1.21, for a Reynolds number, within a range with a lower limit of 10⁴, preferably of 10³, more preferably of 10², even more preferably of 10, still even more preferably of 1 and an upper limit of 6.10⁴, preferably of 10⁵, more 10 preferably of 10⁶, even more preferably of 10⁷, still even more preferably of 10⁸; and a Mach number with an upper limit of 0 3, preferably of 0.4, more preferably of 06, even more preferably of 0.8, still even more preferably of 1.

24. The pressure probe according to claim 18, wherein said open end of said at least one low pressure sensing port is positioned in an open cylinder facing a downstream direction of the fluid flow, which cylinder is coupled to said bulbous part.

25. The method for determining a pressure in a fluid, the method using the pressure probe of claim 1.

26. The method according to claim 25, wherein a differential pressure measurement is performed.

27. The method according to claim 26, wherein said differential pressure measurement is performed in situ.

28. The method according to claim 26, the method further comprising determining the relative flow rate of a fluid from results of said differential pressure measurement.

29. The method according to claim 25, comprising:
using said pressure probe for determining a single pressure value; and
obtaining another pressure value and determining a flow rate based on said single pressure value and said another pressure value.
